(19) United States
(12) Patent Application Publication
(10) Pub. No.: US 2011/0115356 A1
(43) Pub. Date: May 19, 2011

(54) SHELF FOR AN APPLIANCE

(76) Inventors: Jonathan Nash, Lagrange, KY (US); Donald Breit, Louisville, KY (US)

(21) Appl. No.: 12/621,301

(22) Filed: Nov. 18, 2009

(51) Int. Cl. A47B 96/02; A47F 5/00; B23P 11/00

(52) U.S. Cl. 312/408; 211/149; 29/428

(57) ABSTRACT

A spill proof shelf, a refrigerator using the same and a method for assembling a shelf are disclosed. The shelf has a frame, which has a peripheral frame portion having a pair of sliding channels. The shelf further has a plate, which slides into the peripheral frame portion through the sliding channels. The shelf further has a pair of brackets mountable to the frame. The shelf further has a resilient finger, which deforms to allow the plate to slide into the peripheral frame portion and returns to its original configuration to lock the plate relative to the frame.

### CROSS-REFERENCE TO RELATED APPLICATIONS

The present application relates to the application entitled SHELF FOR AN APPLIANCE, attorney docket no. 238653, filed Oct. 21, 2009 under Ser. No. 12/603,320.

### BACKGROUND OF THE INVENTION

The present invention relates generally to shelf assemblies for refrigerators and, more particularly, to spill proof refrigerator shelves which are flexible in replacement of the components of the shelves and economical in manufacture.

A refrigerator typically includes a number of shelves for the storage of food and beverage containers of a variety of shapes and sizes. As the containers are retrieved, returned and rearranged on the shelves, occasional leaks and spilling of food and liquid may occur. Extensive cleanup efforts are required since the spill will commonly flow down through the compartment, from shelf to shelf. Therefore, it is desirable to provide containment implements for the refrigerator to limit the area of such a spill.

Traditionally, a spill proof shelf of a refrigerator includes a frame, a glass pane encapsulated with the frame, and a pair of support brackets mounted to the frame for fixing the shelf in the compartment of the refrigerator. For example, the glass pane can be formed integrally with the frame during the molding of the frame. Therefore, the entire shelf has to be replaced in the event a failure of the shelf occurs, which is often caused by the failure of the glass pane, such as breaking of the glass pane. Accordingly, the cost for replacing refrigerator shelves is increased.

Therefore, it is desirable to provide a refrigerator shelf, which allows the glass pane to be conveniently disassembled and replaced in case of shelf failure.

### SUMMARY OF THE INVENTION

As described herein, the various exemplary embodiments of the present invention overcome one or more of the above or other disadvantages known in the art.

One aspect of the present invention relates to a shelf for a refrigerator. The shelf includes a frame, and a plate supported by the frame. The frame includes a peripheral frame portion for defining a central opening. The frame further includes at least one sliding channel formed in the peripheral frame portion. The plate is supported by the peripheral frame portion. At least a portion of the plate is capable of sliding into the peripheral frame portion through the at least one sliding channel.

Another aspect of the present invention relates to a refrigerator. The refrigerator includes at least one storing compartment and at least one shelf disposed in the compartment. The shelf includes a frame, and a plate supported by the frame. The frame includes a peripheral frame portion for defining a central opening. The frame further includes at least one sliding channel formed in the peripheral frame portion. The plate is supported by the peripheral frame portion. At least a portion of the plate is capable of sliding into the peripheral frame portion through the at least one sliding channel.

Another aspect of the present invention relates to a method of assembling a refrigerator shelf including a frame and a plate supported by the frame. The method includes providing at least one sliding channel in the frame. The method further includes sliding the plate into the frame through the at least one sliding channel.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a perspective view of a refrigerator shelf according to an exemplary embodiment of the present invention;

FIG. 2 is a perspective view of the shelf in FIG. 1, with some components of the shelf removed;

FIG. 3 is a cross section view of the shelf along Lines 3-3 in FIG. 1, prior to the insertion of a plate into a frame of the shelf;

FIG. 4 is a cross section view of the shelf along Lines 3-3 in FIG. 1, after the insertion of the plate into the frame of the shelf;

FIG. 5 is a partially cross section view of the shelf along Lines 5-5 in FIG. 3;

FIG. 6 is a partially perspective view of a support portion of the shelf in FIG. 1;

FIG. 7 is a rear view of the shelf in FIG. 1;

FIG. 8 is a cross section view of the shelf along Lines 8-8 in FIG. 7;

FIG. 9 is a cross section view of the shelf along Lines 3-3 according to another exemplary embodiment of the present invention; and

FIG. 10 is a cross section view of the shelf along Lines 3-3 according to still another exemplary embodiment of the present invention.

### DETAILED DESCRIPTION OF THE EXEMPLARY EMBODIMENTS OF THE INVENTION

It is contemplated that the teaching of the description set forth below is applicable to all types of refrigeration appliances, including but not limited to household refrigerators. The present invention is therefore not intended to be limited to any particular refrigeration apparatus or configuration described in the exemplary embodiments of the present invention.

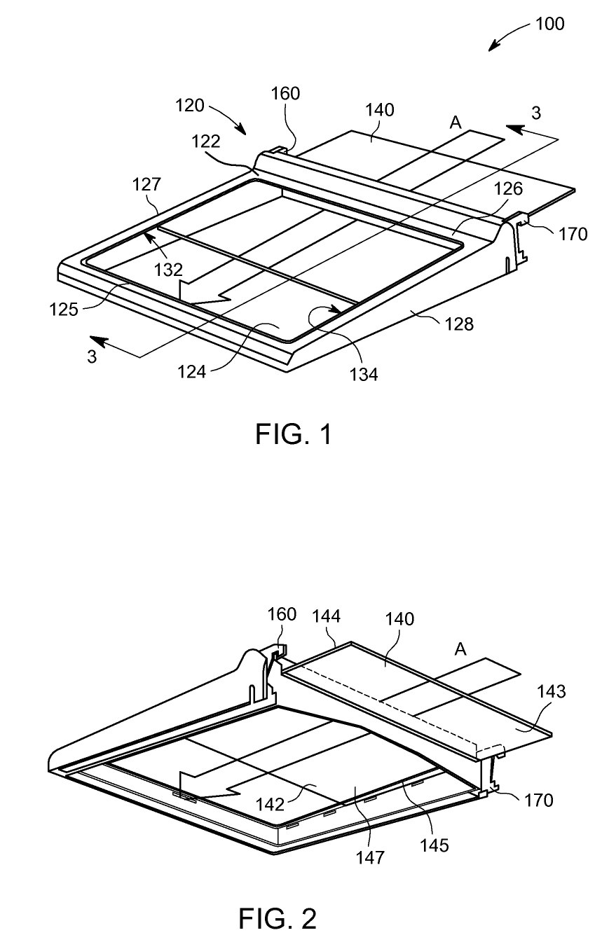

FIG. 1 illustrates an exploded perspective view of a refrigerator shelf 100 according to an exemplary embodiment of the present invention. FIG. 1 also depicts the assembly of a plate to the refrigerator shelf. The shelf 100 includes a frame 120, a plate 140 slidable into the frame 120 and supported by the frame 120, and a pair of support brackets 160 and 170 mountable to the frame 120. The shelf 100 is provided in a storing compartment of a refrigerator, for holding food or beverage containers.

The frame 120 can be fabricated from inexpensive, integrally molded plastic. The materials suitable for the frame 120 include, but are not limited to, talc filled polypropylene, acrylonitrile-butadiene-styrene (ABS), or High Impact Polystyrene (HIPS). Alternatively, the frame 120 can be assembled from a plurality of separate components having complementary mating structures. In the shown embodiment, the frame 120 is a one-piece, substantially rectangular frame, molded from homogeneous polymeric or copolymeric plastic material.

In the shown embodiment, the frame 120 includes a continuous peripheral frame portion 122 and a central opening 124 defined by the peripheral frame portion 122. The peripheral frame portion 122 includes a front frame portion 125, a rear frame portion 126, a left frame portion 127 and a right frame portion 128 connecting the front frame portion 125 and the rear frame portion 126 at the left side and right side of the frame 120, respectively. The opposite front frame portion 125 and rear frame portion 126 are substantially parallel to each other. The opposite left frame portion 127 and right frame portion 128 are substantially parallel to each other and perpendicular to the front frame portion 125 and rear frame portion 126. Accordingly, the peripheral frame portion 122 and the central opening 124 are substantially rectangular.

The plate 140 is capable of supporting food or beverage containers. The plate 140 is substantially flat and rectangular, dimensioned to be substantially complementary to the frame 120 and the central opening 124.

Once the plate 140 is assembled to the frame 120, a containment region is formed by the plate 140 and the peripheral frame portion 122. One or more seals are provided between the frame 120 and the plate 140, substantially around the containment region. Thus, in the event leaks or spilling of the food or beverage occurs, the spilled solid or liquid would be confined in the containment region.

FIG. 2 illustrates another perspective view of the shelf 100, with parts of the shelf removed to better depict the structures of the frame 120, plate 140 and brackets 160 and 170. As shown, the plate 140 includes substantially parallel front edge 142 and rear edge 143, which are retained by the front frame portion 125 and rear frame portion 126 of the frame 120, respectively. The plate 140 further includes substantially parallel left edge 144 and right edge 145, which are retained by the left frame portion 127 and the right frame portion 128, respectively. The plate 140 has an upper surface 147 facing upward, on which the food stored in the refrigerator is placed. The plate 140 further has an opposite lower surface 148 (as best shown in FIG. 4).

The plate 140 can be fabricated from a variety of suitable materials, including but not limited to, glass and plastics. In the shown embodiment, the plate 140 is a rectangular glass pane captured by the portions of the frame 120. However, it should be understood by a person of ordinary skill in the art, that the plate 140 can assume different shapes and profiles, depending on the specific design of the refrigerator.

The frame 120 includes at least one sliding channel, through which at least a portion of the plate 140 slides into the frame 120. In the shown exemplary embodiment, the left frame portion 127 of the frame 120 is provided with a left sliding channel 132, dimensioned to allow the left edge 144 of the plate 140 to slide into the left frame portion 127. The right frame portion 128 is provided with a right sliding channel 134, dimensioned to allow the right edge 145 of the plate 140 to slide into the right frame portion 128.

During the process of assembling the plate 140 to the frame 120, the plate 140 slides into the frame 120 along the direction indicated by arrow A in FIG. 1 from the rear frame portion 126 to the front frame portion 125 of the frame 120, for providing a releasable engagement between the frame 120 and the plate 140.

The pair of brackets 160 and 170 are mounted to the frame 120, optionally through a snap fit. The brackets can be fabricated from a variety of suitable materials, including but not limited to, steel. Furthermore, the number, position and configuration of the brackets can be changed depending on the specific design of the refrigerator.

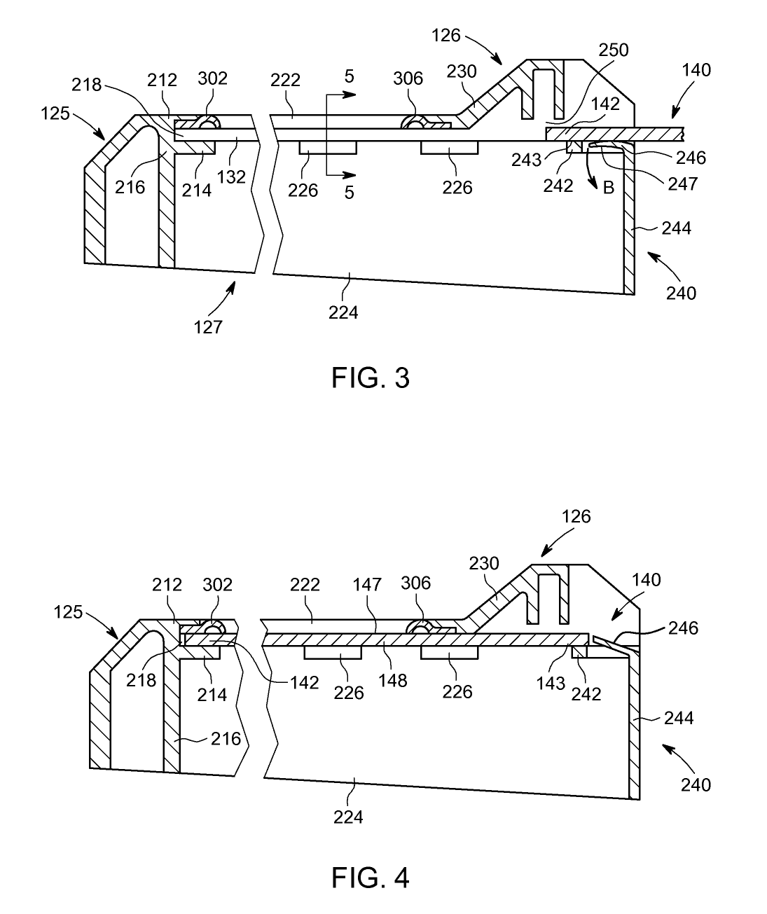

FIG. 3 illustrates a cross section view of the shelf 100 along Lines 3-3 in FIG. 1, prior to sliding the plate 140 into the frame 120. FIG. 4 illustrates a cross section view of the shelf 100 along Lines 3-3, after sliding the plate 140 into the frame 120.

The front frame portion 125 of the frame 120 includes an upper wall 212 and an opposite lower wall 214. The upper wall 212 and the lower wall 214 are connected to each other through a side wall 216. The upper wall 212, the lower wall 214 and the side wall 216 together define a receiving slot 218. The receiving slot 218 is configured to retain the front edge 142 of the plate 140. A seal 302 is provided for sealing the space between the upper wall 212 of the front frame portion 125 and the upper surface 147 of the plate 140. Accordingly, the spilled solid or liquid cannot leak through the shelf 100. The seal 302 can be formed unitarily with the front frame portion 125 of the frame 120, or formed separately and fixed to the front frame portion 125 of the frame 120. For example, the seal 302 is unitarily formed with the front frame portion 125 of the frame 120 through co-injection molding. Alternatively, the seal 302 can be formed on the upper surface 147 of the plate 140, or more than one seal can be formed with both the plate 140 and frame 120 correspondingly for enhancing the sealing result. Materials suitable for forming the seal 302 include, but are not limited to, compressible material, such as TPE (thermoplastic elastomer) and TPO (thermoplastic olefin).

Optionally, a vanishing lubricant can be applied to the seal 302 to reduce the friction between the upper surface 147 of the plate 140 and the seal 302 and to facilitate the sliding of the plate 140. Optionally, a vanishing lubricant can be also applied to the upper surface 147 and/or lower surface 148 of the plate 140 to further reduce the friction and facilitate the sliding of the plate 140. The vanishing lubricant vanishes after the plate 140 slides in position.

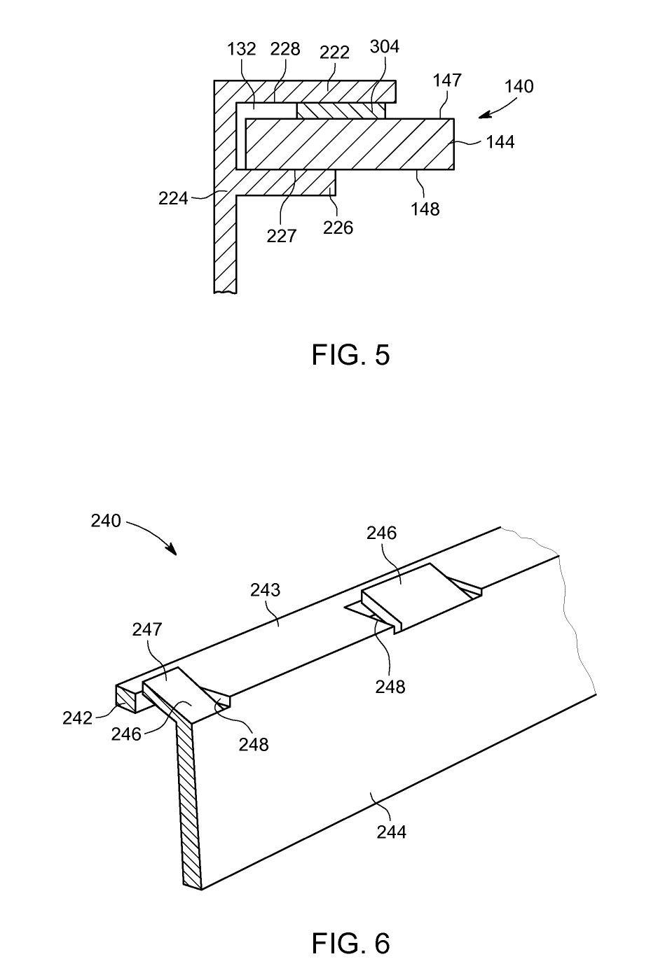

The left frame portion 127 includes an upper wall 222 and a side wall 224 depending from the upper wall 222. The left frame portion 127 further includes a plurality of tabs 226 extending from the side wall 224 toward the interior of the frame 120. FIG. 5 is a cross section view along Lines 5-5 in FIG. 3, illustrating the retention of the left edge 144 of the plate 140 by the left frame portion 127 of the frame 120. Each of the plurality of tabs 226 cantilevers from the side wall 224 and is equally spaced from the upper wall 222. The upper wall 222, the side wall 224 and the plurality of tabs 226 together form the left sliding channel 132. The upper wall 222, the side wall 224 and the plurality of tabs 226 are configured to allow the left edge 144 to slide on the upper surface 227 of the tabs 226, along the left sliding channel 132. The upper wall 222, the side wall 224 and the plurality of tabs 226 can be formed integrally or separately. For example, the upper wall 222, the side wall 224 and the plurality of tabs 226 can be formed unitarily through a single molding step.

A seal 304 is provided between the upper surface 147 of the plate 140 and the lower surface 228 of the upper wall 222 of the left frame portion 127. The seal 304 is dimensioned and formed such that it allows the sliding of the left edge 144 of the plate 140 along the left sliding channel 132, while maintaining the sealing between the left edge 144 of the plate 140 and the upper wall 222 of the left frame portion 127. The seal 304 can be formed unitarily with upper wall 222 of the left frame portion 127, or formed separately and fixed to the upper wall 222 of the left frame portion 127. For example, the seal 304 is unitarily formed with the upper wall 222 of the left frame portion 127 through co-injection molding.

In the shown exemplary embodiment, a plurality of discrete tabs 226, physically separated from each other, are provided for forming the left sliding channel 132. Such a configuration effectively saves material used for forming the sliding channel. However, a person of ordinary skill in the art should understand that any suitable variation of the tabs is within the scope of the present invention, as long as such a variation is capable of forming a same or similar sliding channel. For example, the tabs can be replaced with a continuous lower wall spaced from the upper wall 222 of the left frame portion 127.

Referring back to FIG. 3, the left sliding channel 132 substantially extends from the front frame portion 125 to the rear frame portion 126 of the frame 120. The left edge 144 of the plate 140 slides along the left sliding channel 132 from an opening of the rear frame portion 126 (which will be described later), until it enters the receiving slot 218 of the front frame portion 125.

The right sliding channel 134 in the right frame portion 128 can be formed similarly or symmetrically to the left sliding channel 132, and the description thereof is omitted for brevity. However, it should be understood by a person of ordinary skill in the art, that the structures for forming the left sliding channel and the right sliding channel can be variation to each other, instead of similar or symmetrical to each other, as long as the left and right sliding channels both function to receive a sliding edge of the plate. Furthermore, a seal, similar or same to the seal 304, can be provided to the right frame portion 128.

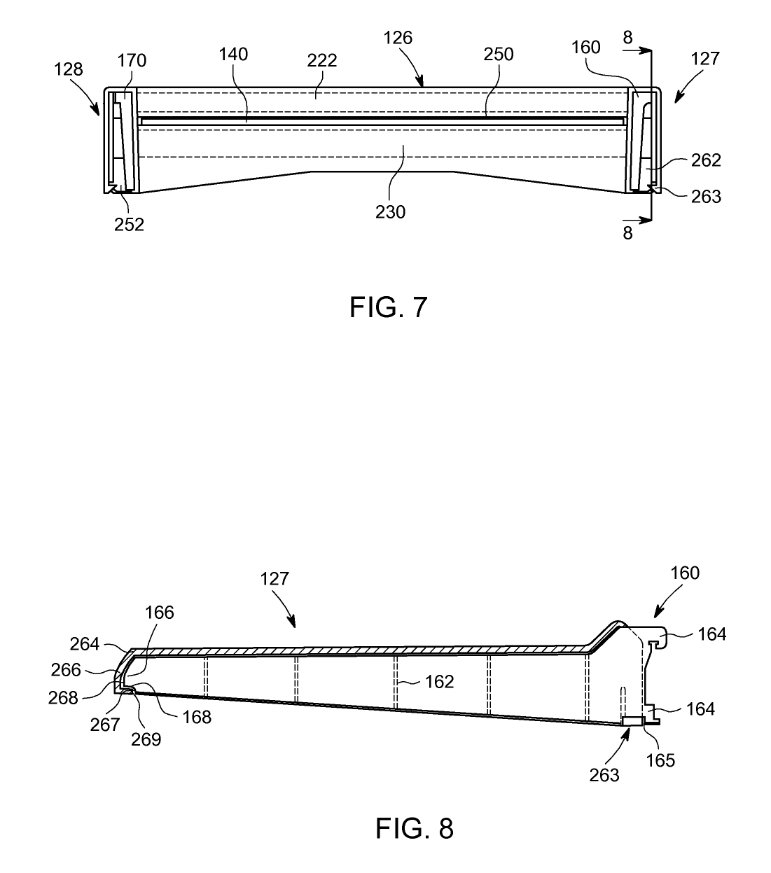

The rear frame portion 126 includes an upper portion 230 disposed above the plate 140 and a support portion 240 disposed under the plate 140. The upper portion 230 and the support portion 240 are spaced from each other to define an elongated opening 250 (which can also be seen in FIG. 7), through which the plate 140 enters the frame 120. Furthermore, the left edge 144 and right edge 145 of the plate 140 enter the left sliding channel 132 of the left frame portion 127 and the right sliding channel 134 of the right frame portion 128 through the opening 250, respectively. After the plate 140 fully slides into the frame 120, the rear edge 143 of the plate 140 is disposed between the upper portion 230 and support portion 240, and rests on the support portion 240, as shown in FIG. 4.

FIG. 6 illustrates a partial perspective view of the support portion 240. The support portion 240 includes a top wall 242 having a top surface 243, and a side wall 244 depending from the top wall 242. The plate 140 rests on the top surface 243 after the plate 140 is slid into the frame 120. The support portion 240 further includes at least one resilient finger 246, which can be at least partially deformed by a biasing force and return to its original configuration after the biasing force is released.

In the shown exemplary embodiment, the resilient finger 246 includes a terminal end 247 extending vertically above the top surface 243 of the top wall 242. The resilient finger 246 is substantially surrounded by a continuous slot 248, formed through the top wall 242. The resilient finger 246 is capable of partially deflecting or bending by a biasing force, to allow the terminal end 247 to be substantially in flush with the top surface 243 of the top wall 242. Once the biasing force is released, the resilient finger 246 is capable of returning to its original configuration, to allow the terminal end 247 to spring back to again extend vertically above the top surface 243 of the top wall 242.

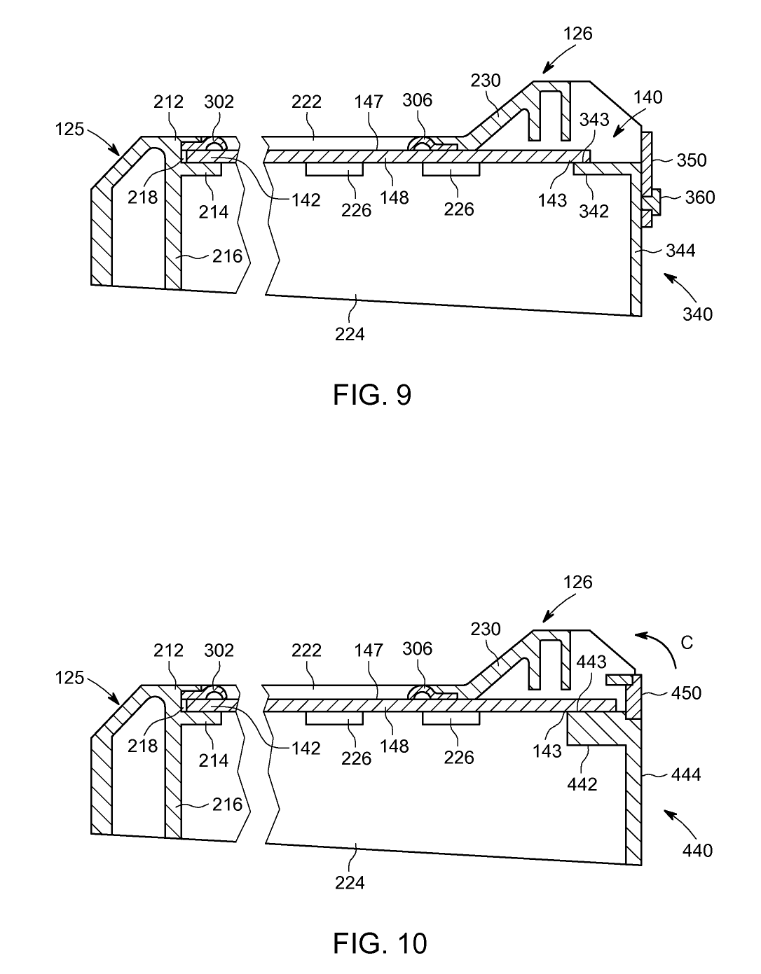

Referring back to FIG. 3, when the plate 140 enters the opening 250 of the rear frame portion 126 along the top surface 243 of the top wall 242, the front edge 142 of the plate 140 engages the terminal end 247 of the resilient finger 246. Thus, the resilient finger 246 deflects along the direction indicated by arrow B in the figure. As a result, the terminal end 247 of the resilient finger 246 is flush with the top surface 243 of the top wall 242, to allow the plate 140 to slide into the frame 120. As shown in FIG. 4, as the rear edge 143 passes over the terminal end 247 of the resilient finger 246, the resilient finger 246 returns to its original configuration. As a result, the terminal end 247 of the resilient finger 246 bounces back to extend vertically above the top surface 243 of the top wall 242, to effectively prevent the plate 140 from sliding out of the frame 120 accidentally. Alternatively, a discrete stop, formed separately from the side wall 244, can be formed in addition to the resilient finger 246 to prevent the plate 140 from sliding out of the frame 120 accidentally. Further embodiments for preventing the plate 140 from sliding out of the frame 120 will be described later, in connection with FIGS. 9 and 10.

A seal 306 is provided between the upper portion 230 of the rear frame portion 126 and the top surface 147 of the plate 140. The seal 306 can be formed unitarily with upper portion 230, or formed separately and fixed to the upper portion 230. For example, the seal 306 is unitarily formed with the upper portion 230 through co-injection molding.

Once the plate 140 fully slides into the frame 120, the front edge 142 is received by the receiving slot 218, the left edge 144 is supported by the tabs 226 (the right edge 145 is supported by same or similar structures), and the rear edge 143 is supported by the top wall 242 of the support portion 240. Furthermore, seals are provided between the top surface 147 of the plate 140 and the surfaces of the frame 120 facing the top surface 147 of the plate 140. Accordingly, the shelf 100 is spill proof.

In the above exemplary embodiment, the plate 140 slides from the rear frame portion 126 toward the front frame portion 125, along the sliding channels 132 and 134 formed in the left frame portion 127 and right frame portion 128, respectively. However, a person of ordinary skill in the art should understand that the configuration in the exemplary embodiment can be adjusted without departing from the scope of the invention. For example, the plate 140 may slide from the front frame portion 125 toward the rear frame portion 126, or from one side portion to the other side portion.

FIG. 7 is a rear view of the shelf 100. As shown, the right frame portion 128 includes a right receiving channel 252 for mounting the right bracket 170, and the left frame portion 127 includes a left receiving channel 262 for mounting the left bracket 160.

FIG. 8 is a cross section view of the left frame portion 127 along Lines 8-8 in FIG. 7, illustrating the engagement between the left bracket 160 and the left frame portion 127. The left bracket 160 includes an elongated base portion 162 having a profile substantially complementary to that of the left frame portion 127. The elongated portion 162 extends substantially from the front side to the rear side of the frame 120.

At the rear end of the elongated base portion 162, the left bracket 160 is provided with vertically spaced hooks 164. The hooks 164 are configured to engage, for example, cant tracks of a refrigerator to mount the shelf 100 to the refrigerator. Adjacent to the lower hook 164, the left bracket 160 further includes a recess 165 configured to engage a complementary protrusion 263 of the left frame portion 127, to provide a snap fit for mounting the bracket 160 to the left frame portion 127.

The left frame portion 127 includes a top wall 264 and a side wall 266 depending from the top wall 264. The side wall 266 is sloped relative to the top wall 264 and is provided with a finger 267 extending inwardly from the lower end of the side wall 266. The side wall 266 and the finger 267 together define a pocket 268. At the front end of the elongated base portion 162, the left bracket 160 is provided with a protrusion 166, which extends into the pocket 268 to releasably engage an under surface 168 of the protrusion 166 with an upper surface 269 of the finger 267. The engagement between the protrusion 166 and the finger 267 at the front end of the elongated base portion 162 and the snap fit provided by the recess 165 and the protrusion 263 at the rear end of the elongated base portion 162 implement the mounting of the left bracket 160 to left frame portion 127 of the frame 120. Alternatively, the left bracket 160 can be attached to the side wall 266 with fasteners or through heat stakes.

FIGS. 9 and 10 illustrates other exemplary embodiments for preventing the plate 140 from sliding out of the peripheral frame portion 122 of the frame 120, after the plate 140 is slid into the frame 120 through the sliding channels 132 and 134. In FIGS. 9 and 10, same components as those shown in FIGS. 3, 4 and 6 are identified by same reference numerals.

As shown in FIG. 9, according to this exemplary embodiment, the rear frame portion 120 includes a support portion 340. The support portion 340 includes a top wall 342 having a top surface 343, and a side wall 344 depending from the outer end of the top wall 342. FIG. 9 shows the plate 140 resting on the top surface 343 of the top wall 342, after the plate 140 is slid into the frame 120. In this embodiment, a stopper 350 is fixable to the side wall 344 of the support portion 340 through a fastener 360 after the plate 140 is slid into the frame 120. Once the stopper 350 is fixed to the side wall 344, the stopper 350 extends vertically above the top surface 343 of the top wall 342, for preventing the plate 140 from moving backwardly and sliding out of the frame 120. The fastener 360 extends through the stopper 350 and is further fixed to the side wall 344 though any know means, such as glue or screw.

FIG. 10 illustrates a support portion 440 according to another embodiment of the present invention. The support portion 440 includes a top wall 442 having a top surface 443, and side wall 444 depending from the outer end of the top wall 442. The plate 140 rests on the top surface 443 of the top wall 442, after the plate 140 is slid into the frame 120. In this embodiment, a living hinge 450 is molded to the side wall 444, in an open position to allow the plate 140 to slide into the frame 120. After the plate 140 is placed in position within the frame 120, the living hinge 450 is pivoted to a closed position along arrow C shown in FIG. 10. Thus, the living hinge 450 is bent over the rear edge 143 of the plate 140, for preventing the plate 140 from moving backwardly and sliding out of the frame 120.

Thus, while there have shown and described and pointed out fundamental novel features of the invention as applied to various specific embodiments thereof, it will be understood that various omissions and substitutions and changes in the form and details of the apparatus illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A shelf comprising:
a frame, comprising a peripheral frame portion and at least one sliding channel formed in the peripheral frame portion, the peripheral frame portion defining a central opening; and
a plate supported by the peripheral frame portion, at least a portion of the plate capable of sliding into the peripheral frame portion through the at least one sliding channel.

2. The shelf of claim 1, further comprising at least one bracket mountable to the frame.

3. The shelf of claim 1, wherein the peripheral frame portion comprises substantially parallel front and rear frame portions and substantially parallel left and right frame portions.

4. The shelf of claim 3, wherein the plate comprises substantially parallel front and rear edges retained by the front and rear frame portions, respectively, and substantially parallel left and right edges retained by the left and right frame portions, respectively.

5. The shelf of claim 4, wherein at least one of the left and right frame portions comprises an upper wall, a side wall depending from the upper wall, and at least one tab formed on the side wall and spaced from the upper wall, the upper wall, the side wall and the at least one tab defining said at least one sliding channel.

6. The shelf of claim 3, wherein the rear frame portion comprises an upper portion and a support portion, spaced from each other to define an opening for admitting the plate, and wherein the support portion comprises a top wall having a top surface for supporting the rear edge of the plate, and a side wall depending from the top wall.

7. The shelf of claim 6, wherein the support portion further comprises at least one resilient finger, the finger being configured to deform under a biasing force and return to an original configuration thereof after the biasing force is released.

8. The shelf of claim 7, wherein the at least one resilient finger comprises a terminal end, the terminal end configured to be flush with the top surface when the finger deforms under a biasing force, the terminal finger further configured to extend beyond the top surface of the top wall when the biasing force is released.

9. The shelf of claim 6, further comprising a stopper fixable to the side wall of the support portion through a fastener, the stopper extending vertically above the top surface of the top wall.

10. The shelf of claim 6, further comprising a living hinge coupled to the side wall of the support portion in an open position thereof to allow sliding the plate into the frame, the living hinge being bendable to a closed position thereof.

11. A refrigerator comprising:
at least one storing compartment; and
at least one shelf disposed in the compartment, comprising:
a frame, comprising a peripheral frame portion and at least one sliding channel formed in the peripheral frame portion, the peripheral frame portion defining a central opening; and
a plate supported by the peripheral frame portion, at least a portion of the plate capable of sliding into the peripheral frame portion through the at least one sliding channel.

12. The refrigerator of claim 11, further comprising at least one bracket mountable to the frame.

13. The refrigerator of claim 11, wherein the peripheral frame portion comprises substantially parallel front and rear frame portions and substantially parallel left and right frame portions.

14. The refrigerator of claim 13, wherein the plate comprises substantially parallel front and rear edges retained by the front and rear frame portions, respectively, and substantially parallel left and right edges retained by the left and right frame portions, respectively.

15. The refrigerator of claim 13, wherein at least one of the left and right frame portions comprises an upper wall, a side wall depending from the upper wall, and at least one tab formed on the side wall and spaced from the upper wall, the upper wall, the side wall and the at least one tab defining said at least one sliding channel.

16. The refrigerator of claim 13, wherein the rear frame portion comprises an upper portion and a support portion, spaced from each other to define an opening for admitting the plate, and wherein the support portion comprises a top wall having a top surface for supporting the rear edge of the plate, and a side wall depending from the top wall.

17. The refrigerator of claim 16, wherein the support portion further comprises at least one resilient finger, the finger being configured to deform under a biasing force and return to an original configuration thereof after the biasing force is released.

18. The refrigerator of claim 17, wherein the at least one resilient finger comprises a terminal end, the terminal end configured to be flush with the top surface when the finger deforms under a biasing force, the terminal finger further configured to extend beyond the top surface of the top wall when the biasing force is released.

19. The refrigerator of claim 16, further comprising a stopper fixable to the side wall of the support portion through a fastener, the stopper extending vertically above the top surface of the top wall.

20. The refrigerator of claim 16, further comprising a living hinge coupled to the side wall of the support portion in an open position thereof to allow sliding the plate into the frame, the living hinge being bendable to a closed position thereof.

21. A method of assembling a refrigerator shelf comprising a frame and a plate supported by the frame, comprising:
providing at least one sliding channel in the frame; and
sliding the plate into the frame through the at least one sliding channel.

22. The method of claim 21, further comprising:
providing at least one resilient finger to the frame;
deforming the at least one resilient finger to allow sliding the plate into the frame through the at least one sliding channel; and
locking the plate relative to the frame by returning the at least one resilient finger to an original configuration thereof.
